(19) United States
(12) Patent Application Publication
(10) Pub. No.: US 2007/0113098 A1
(43) Pub. Date: May 17, 2007

(54) Grip security arrangement

(75) Inventor: Curt D. Croley, Stony Brook, NY (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: Symbol Technologies, Inc., Holtsville, NY (US)

(21) Appl. No.: 11/273,213

(22) Filed: Nov. 14, 2005

(51) Int. Cl. H04K 1/00

(52) U.S. Cl. 713/186

(57) ABSTRACT

Systems and methods that enhance a user's grip on a hand held terminal (e.g., during one handed operation) via employing a grip securing arrangement. Such grip security arrangement includes a depression positioned to at a back surface of the hand terminal to receive a user's finger (e.g., index finger). Accordingly, such finger can function as a pivot point to provide additional support for stability (e.g., moment and balance). Thus, holding the device can be facilitated during one handed operation.

### BACKGROUND

With the recent increase in network computing applications, wireless information transfer, and internet applications, the number of applications for which data processing systems are employed has increased correspondingly. Mobile computing units such as personal digital assistants (PDA), notebook and laptop personal computers (PCs) have become increasingly popular due to their portability and increased functionality.

Many of such mobile computing units are handheld devices, or palm-size devices, which comfortably fit within the hand. For example, one commercially available mobile device is sold under the trade name HandHeld PC (or H/PC). Such units are generally assembled by enclosing internal electrical components, such as a central processing unit (CPU) board, display, keyboard, and internal wiring, within a housing made of plastic or another structural material. The enclosure normally serves as a protective measure and is typically formed in two parts having an upper housing and a lower housing. The electronic components can be mounted to one or both sides of the housing.

For example, the mobile device includes a processor, random access memory (RAM), and an input device such as a keyboard and a display, wherein the keyboard can be integrated with the display, such as a touch sensitive display. A communication interface is optionally provided and is commonly used to communicate with a desktop computer. A replaceable or rechargeable battery powers the mobile device. Optionally, the mobile device can receive power from an external power source that overrides or recharges the built-in battery, such as a suitable AC or DC adapter, or a powered docking cradle.

Many of these mobile computing units are inform of hand held terminals/scanners that do not have a handle, and a user typically holds the units in the palm of a hand during use. Generally, a desirable characteristic of such terminals is that they can readily function, while a respective user performs other more demanding tasks.

As explained, commonly such electronic devices are small enough to be grasped via the palm of a user's hand. Also, these devices typically include a keypad that enables users to enter data. Such keypads can be of different sizes and configurations that employ different alpha numerical keys. With such small size of the devices and different key pad configurations it is desirable to be able to quickly enter data, for example with one hand, where that one hand not only supports the device but is also able to quickly enter data or commands.

Accordingly, a user may find it necessary to operate a data terminal with one hand, while leaving the other hand free. In particular, the user may find it desirable to lift or otherwise shift small items of inventory with one hand, while simultaneously scanning them with the portable scanner held in the other hand.

Nonetheless, during one handed operation, such terminals/mobile computing units are generally susceptible to fall, which can damage the electronic circuitry. For example, a balance of the device may be readily become unstable when the user is trying to insert data via a thumb and at the same time holding the device in the palm.

Additionally, wrapping additional accessories around the body of such mobile computing units can further reduce a user's grip balance and ease of use, causing early fatigue for a user. Moreover, often the hand held scanner needs to be oriented at various angles for a proper reading of the bar code symbol display. At such slanted angles, it is typically difficult for a user to readily hold a firm grip on the device.

Therefore, there is a need to overcome the aforementioned exemplary deficiencies associated with conventional devices.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject innovation provides for systems and methods of enhancing a user's grip on a mobile computing unit/hand held terminal (e.g., during one handed operation) via employing a grip securing arrangement that includes a depression positioned at a back surface of the hand terminal, to receive a user's finger (e.g., index finger). Such depression can include a surface(s) (e.g., curved) as part of associated ledges that contours the user's finger. Accordingly, the finger in contact with the depression can function as a pivot point to provide additional support for stability (e.g., moment and balance). Thus, holding the device can be facilitated during one handed operation, wherein the user employs one hand for both grasping the device and operating therewith.

In a related aspect, such a depression can be in form of a groove having a curved surface, to contour a user's finger. Such groove can also be formed via an inclined or vertical ledge on one side, and the back surface of the hand terminal as the other side. A user's finger can then be positioned in the groove while the device is held in palm of the hand. In addition, balancing a weight of the mobile computing unit, and resulting moments induced can be mitigated by user's adjusting orientation of the user's finger within the depression. Thus, a distribution of weight for the hand held computing hand in a user's palm can be facilitated, while at the same time mitigating grip instabilities that can arise during one handed operation. The groove can be symmetrical with respect to a longitudinal axis passing thru the device, and hence support both left handed and right handed users.

Moreover, the securing arrangement of the subject innovation can be molded as one piece or as separate unit that can be connected to the back surface of the mobile device. When attached as a separate unit to the mobile computing unit, the location for attachment can be selected based on a user's preference. Moreover, the securing arrangement can include elastomeric material having slip-resistant characteristics.

As such, the depression associated with the grip security arrangement can include slip-resistant textures formed at a portion thereof, to contact a user's finger that is positioned within the depression. The slip resistant texture can have a uniform thickness throughout the depression or alternatively can have a varying thickness therein.

In accordance with a methodology of the subject innovation, a depression can be formed as part of the back surface of the hand held scanner during a molding operation of the housing for the portable terminal. Alternatively, the depression can be part of a separate unit (e.g., a gripping arrangement) that is attached to the back of the portable terminal housing after a manufacture thereof.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a perspective view of a mobile computing unit with a depression as part of grip security arrangement of the subject innovation.

FIG. 2 illustrates a plan view of a back side of the mobile computing unit according to an aspect of the subject innovation.

FIG. 3 illustrates a cross section of the mobile computing unit in accordance with an aspect of the subject innovation.

FIG. 4 illustrates a detailed side view for form of the depression associated with the grip security arrangement of the subject innovation.

FIG. 5 illustrates another detailed side view for form of the depression associated with the grip security arrangement of the subject innovation.

FIG. 6 illustrates a hand held terminal with a grip enhancement feature in accordance with an aspect of the innovation.

FIG. 7 illustrates a methodology of implementing a grip security arrangement in accordance with an aspect of the subject innovation.

FIG. 8 illustrates a further methodology of employing a grips security arrangement as part of the mobile computing unit.

FIG. 9 illustrates a schematic diagram that depicts a system for molding a depression as part of grip security arrangement as part of a back cover for the mobile computing unit.

FIG. 10 illustrates a further methodology of implementing a grip security arrangement in accordance with an aspect of the subject innovation.

FIG. 11 illustrates a general block lay out of a device employing the grip security arrangement of the subject innovation.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the subject innovation can be practiced without these specific details. In other instances, well-known structures and devices are shown in block diagram form in order to facilitate describing the subject innovation.

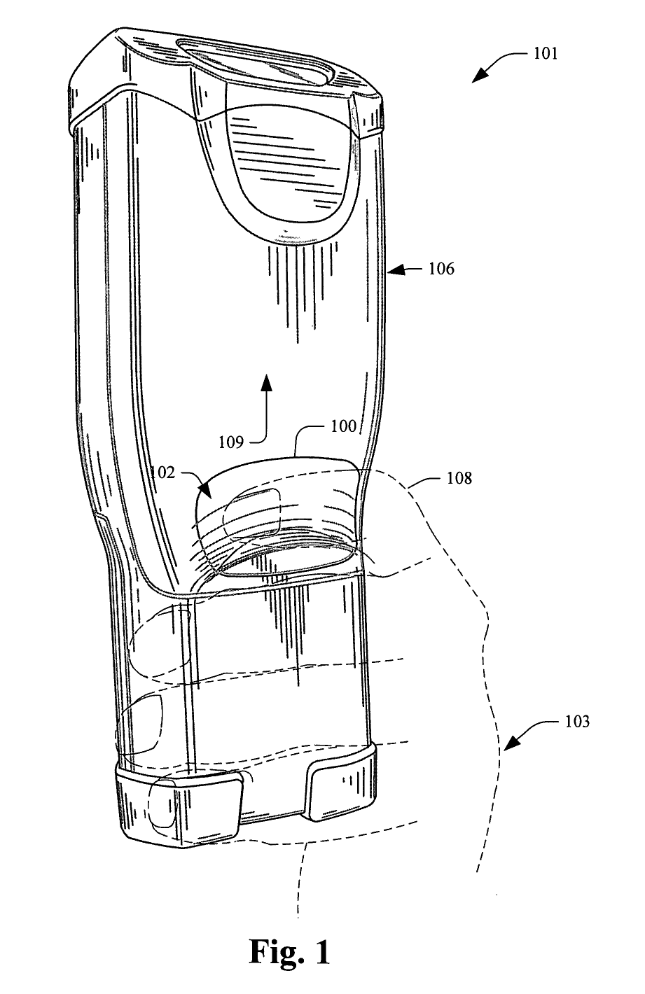

Referring initially to FIG. 1, there is illustrated a perspective view of a mobile computing unit 101 with a depression 102 as part of grip security arrangement 100, in accordance with an exemplary aspect of the subject innovation. When the handheld computing unit 101 is held in a user's hand 103, the depression 102 at the back surface of the housing 106 can receive a user's finger, e.g., an index finger 108. The user can then employ the thumb for operation with the keypad located on a front side of the hand held computing unit 101. Such enables the user to enter alphanumeric text and data using only one hand, with additional balance control of the hand held computing unit.

The finger 108 (e.g., index finger) can maintain a naturally curved position when placed in the depression 102, and enhance a user's grip. In addition, balancing a weight of the mobile computing unit 101, and resulting moments induced (e.g., cantilever positioning of portion 109—wherein the finger 108 acts as a pivot point—can be mitigated by user's adjusting orientation of the finger 108, within the depression 102. Thus, a distribution of weight for the mobile computing unit 101 in a user's palm can be facilitated, while at the same time mitigating inertial effects that can result from motion of the user's thumb when touching the keypad.

For example, the depression 102 can be in form of a groove having a curved surface, to contour a user's finger 108. As will be described in detail infra, such groove can also be formed via an inclined or vertical ledge on one side, and the back surface of the hand terminal as the other side. A user's finger 108 can then be positioned in the groove while the device is held in palm of the hand. The groove can be symmetrical with respect to a longitudinal axis passing thru the device, and hence support both left handed and right handed users.

Ledges/edges of such groove can be angled to approximate the natural form of a user's finger to contour a perimeter thereof (e.g., sides of the finger), while using the device. Also, the securing arrangement 100 can employ rubber material to enhance a contact with the user's finger 108. The grip edges can be rounded off so that the portion of the grip which contacts an index finger is comfortable to the users, for example. This inward tapering of the grips improves a control of the movement of the mobile computing unit 101 within a user's hand.

Moreover, a grip and control for the device can be enhanced during one handed operation, wherein the user employs one hand for both grasping the device and operating the keypad. The thumb of the user can then operate a key pad of the mobile computing unit 101. The keypad can be a self contained key pad assembly that is over molded around a boundary defined by and/or common to a top cover and bottom cover, wherein the top cover and the bottom cover encapsulate a plurality of key pad components packed together. Such over molding around the pack of keypad components can create a protective seal against outside contaminants and mitigate damage thereto. Such keypad can be employed to enter information concerning modes of operation of the hand held computing unit 101 or to carry out cancellation or manipulation operations on information provided by the hand held computing unit 101.

The grip security arrangement 100 can be incorporated into a variety of electronic devices, such as for example, portable hand held terminals, personal digital assistants, pagers, cellular phones, G.P.S. transceivers, remote controls, and the like. It is to be appreciated that the securing arrangement 100 can be molded as one piece or as separate part that can be connected to the back surface of the mobile computing device and/or housing. When attached as a separate unit the location for attachment can be selected based on a user's preference.

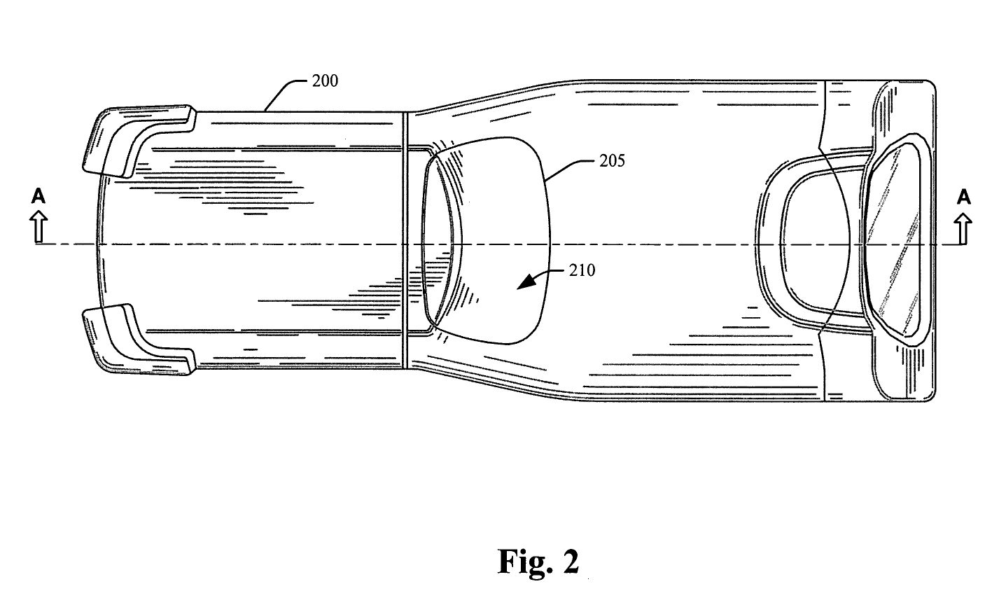

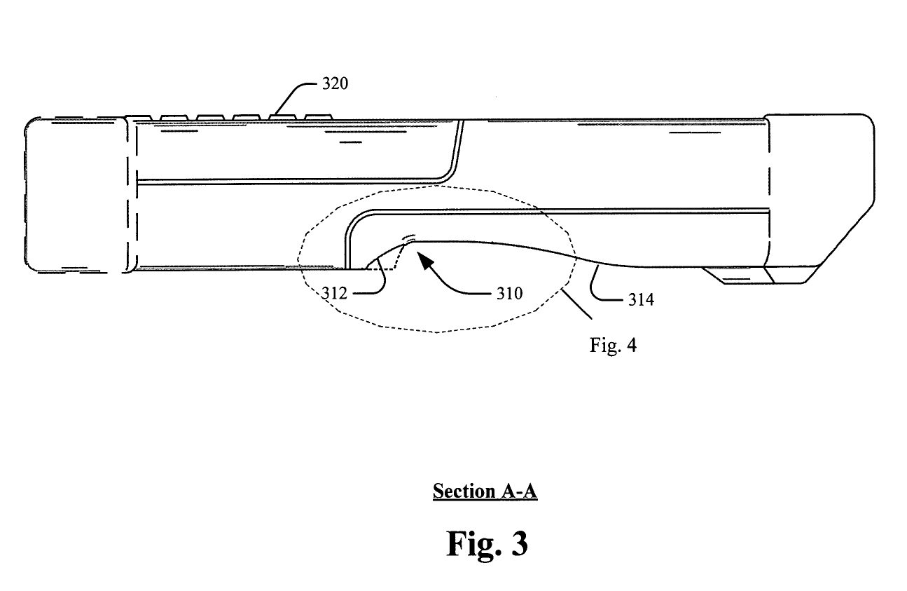

FIG. 2 illustrates a plan view of a back side of a housing associated with the mobile computing unit according to an aspect of the subject innovation. The back surface 200 incorporates a grip security arrangement 205. The grip security arrangement can include a depression 210. As explained earlier, the depression 210 associated with the grip security arrangement 205 can include slip-resistant textures formed at a portion thereof to contact a user's finger that is positioned within the depression. The slip resistant texture can have a uniform thickness throughout the depression or alternatively can have a varying thickness therein. Longitudinal cross section A-A of the back surface 200 is illustrated in FIG. 3, wherein the depression 310 can receive a user's finger, e.g., an index finger, and the user can then employ the thumb for operation with the keypad 320 located on a front side of the hand held computing unit.

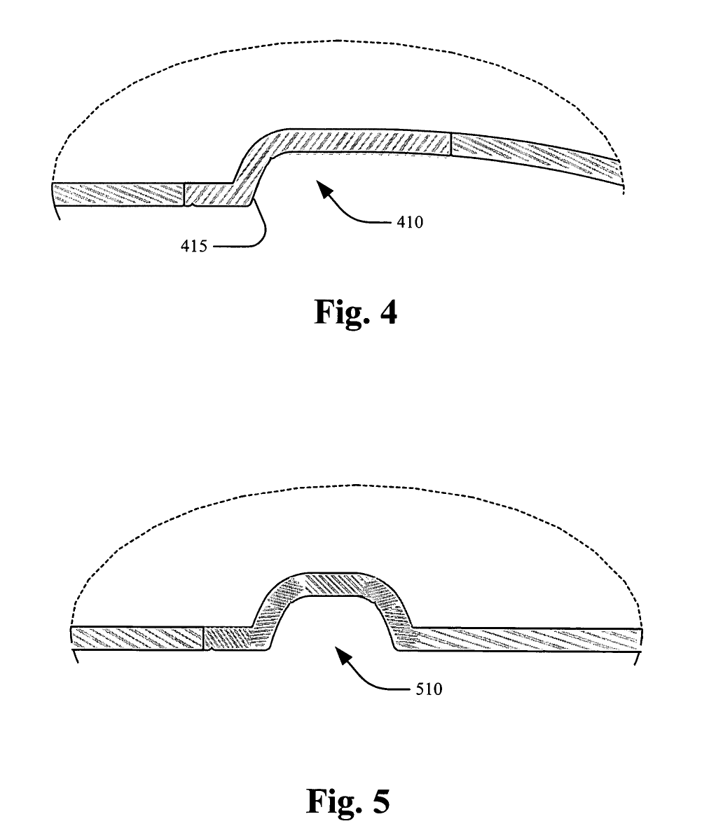

As illustrated in FIG. 3, the depression 310 can be formed on one side by an inclined ledge 312 (or vertical) and the back surface of the housing 314 for the mobile computing unit. It is to be appreciated that the depression can also be in a form of a groove as illustrated in detail of FIG. 4 with two inclined surfaces (e.g., curved) wherein a user's finger can be positioned within the groove 410, wherein the side 415 can trace around a user's finger (e.g., contour).

As such, while the user's finger is in the groove 410, the mobile computing device is held in palm of the hand, and balancing a weight thereof can be facilitated to improve the overall stability. For example, resulting moments induced can be mitigated by user's adjusting orientation of the user's finger, within the groove. The groove can be symmetrical with respect to a longitudinal axis passing thru the device, and hence support both left handed and right handed users.

As explained earlier, the security arrangement of the subject innovation can be employed in a variety of electrical or electronic device that can require one handed operation and/or entry of a user's input via pressing alpha, alphanumerical designations or keys thereon. Examples of such devices can include, palm pilots, mobile phones, telephones, faxes, computers, mini computers, scanners, terminals, and the like. FIG. 5 illustrates another exemplary aspect of a groove 510 for accepting a user's finger as part of the grip security arrangement. It is to be appreciated that other shapes can also be employed to form the groove and/or depression as part of the grip security arrangement of the subject innovation.

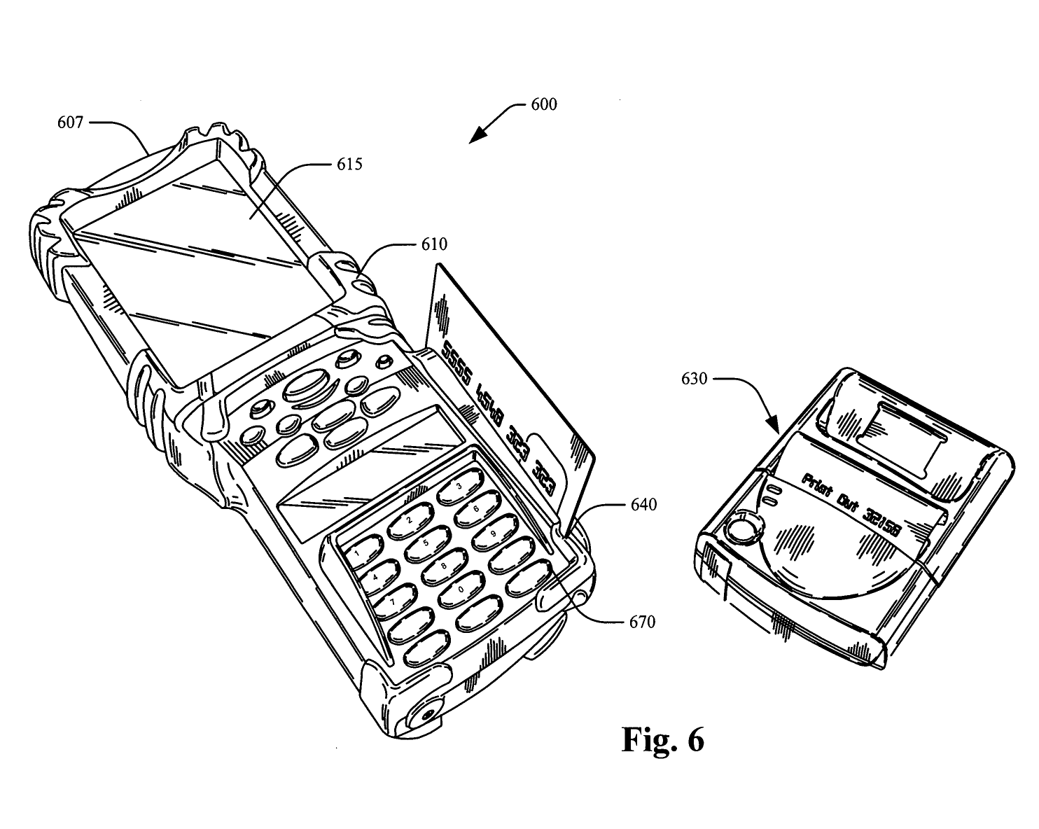

One particular device that can incorporate such grip security arrangement is a handheld terminal 600 of FIG. 6 that includes a depression on a back side in accordance with an aspect of the subject invention. In particular, a user can primarily employ a thumb for keying during one handed operation, wherein the grip security arrangement having a depression for accepting middle/index fingers, can facilitate holding the hand held terminal 600 in a secure position. The handheld terminal 600 includes a housing 610 which can be constructed from a high strength plastic, metal, or any other suitable material. The portable terminal 600 can also include a display 615 functions to display data or other information relating to ordinary operation of the handheld terminal 600 and/or mobile companion 630.

Additionally, the display 615 may display a variety of functions that are executable by the handheld terminal 600 and/or one or more mobile companion(s) 630. The display 615 can provide for a touch screen interface that can employ capacitive, resistive touch, infrared, surface acoustic wave, or grounded acoustic wave technology.

The handheld terminal 600 can also include a magnetic strip reader 640 or other data capture mechanism. The handheld terminal 600 can also include a window 607 in which a bar code reader/bar coding imager is able to read a bar code label, or the like, presented to the handheld terminal 600. The handheld terminal 600 can include a LED (not shown) that is illuminated to reflect whether the bar code has been properly or improperly read. Alternatively, or additionally, a sound may be emitted from a speaker (not shown) to alert the user that the bar code has been successfully imaged and decoded. The handheld terminal 600 also includes an antenna (not shown) for wireless communication with an RF access point; and an IR transceiver (not shown) for communication with an IR access point.

The keypad 670 can include a top cover and a bottom cover that can be over molded around a common boundary. The top cover and the bottom cover can sandwich a plurality of associated keypad components (e.g., flex members, electro luminous panel, a silicone membrane with a plurality of keys thereupon printed circuit boards, LEDs, and the like). The common boundary can be formed by a surface area and/or line perimeter common to the top cover and the bottom cover, (e.g. a contact surface between top and bottom cover, a surface encapsulating the keypad components, edges of the stacked components and the like.) Typically, materials employed for fabricating the back cover with the depression can include various types of polycarbonates, thermoset plastics, thermoformed plastic, and typically material that are capable of being molded to provide a suitable depression/groove for accepting a user's finger as described in detail supra.

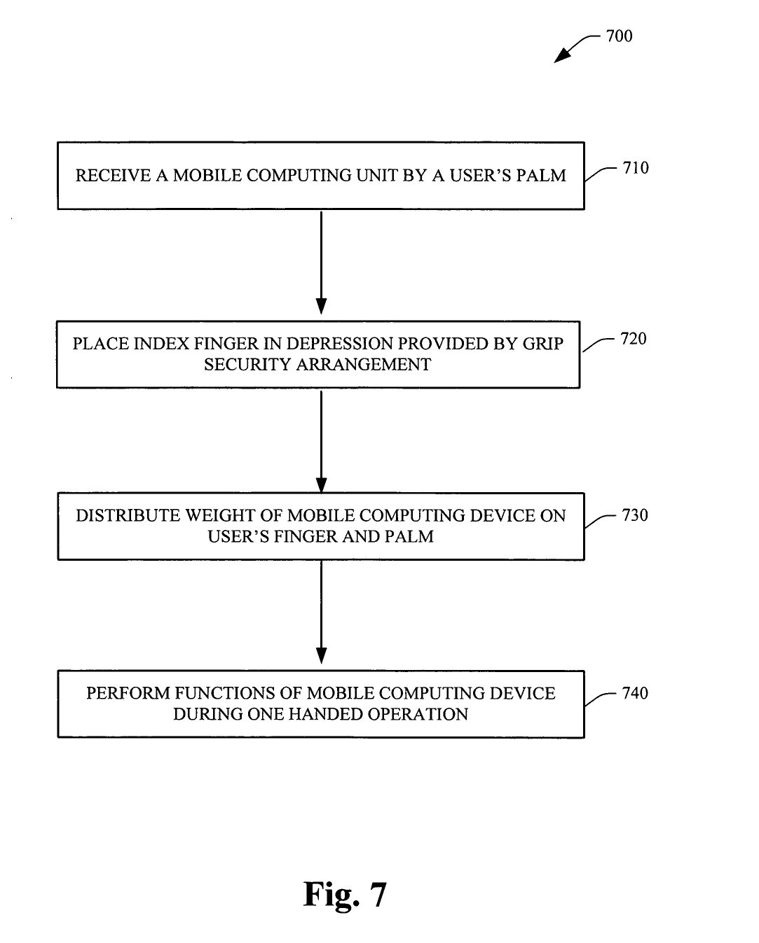

FIG. 7 illustrates a particular methodology 700 of implementing a grip security arrangement in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially and at 710, a mobile computing unit with a grip security arrangement is positioned in a user's hand. The user can then place an index finger in the depression supplied as part of the grip security arrangement in the back side of the mobile computing unit, at 720. As such, balancing a weight of the mobile computing unit, and resulting moments induced can be mitigated by user's adjusting orientation of the user's finger. Thus, at 730 a distribution of weight for the hand held computing hand in a user's palm can be facilitated, while at the same time mitigating grip instabilities that can arise during one handed operation. The user can then proceed with one handed operation of the mobile computing unit at 740.

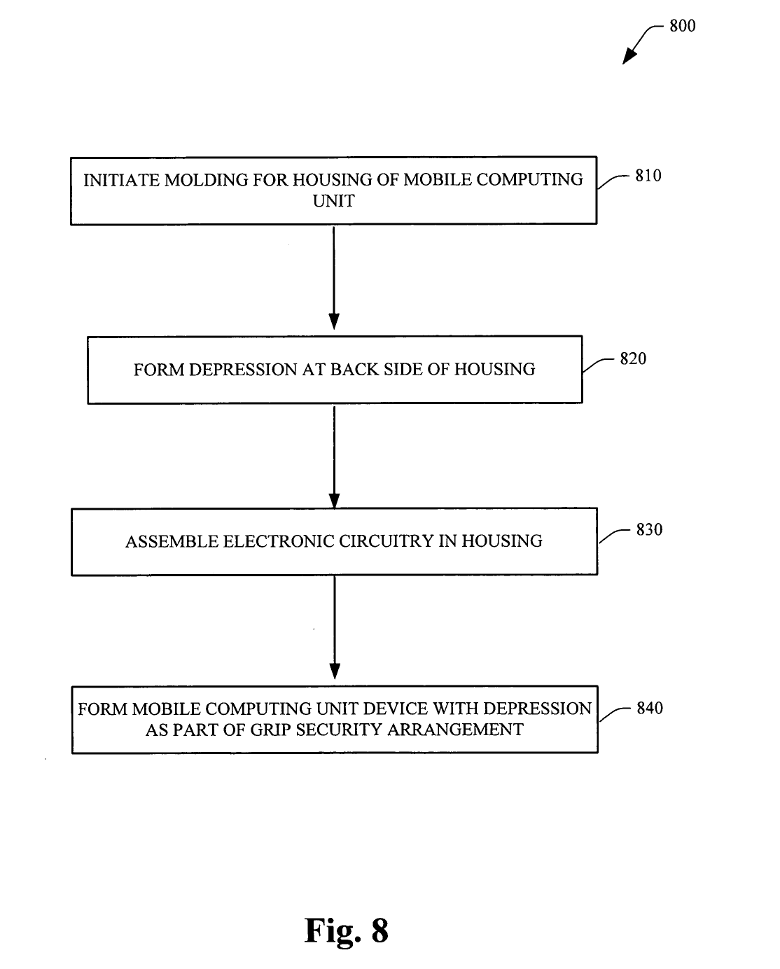

FIG. 8 illustrates an exemplary methodology 800 of employing a grip security arrangement as part of the mobile computing unit. At 810 molding for a housing of the mobile computing unit can be initiated. At 820, a depression as described in detail infra can be formed on the back side of housing. Next, and at 830 electronic circuitry associated with the mobile computing unit can be placed within the housing. The mobile computing unit can then be supplied for one handed operation by a user at 840.

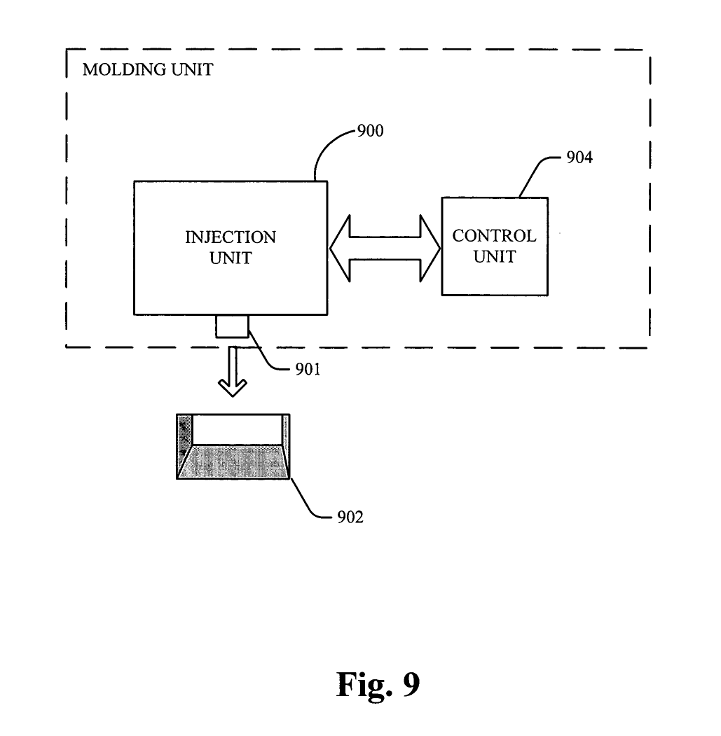

Referring now to FIG. 9, a schematic diagram depicts a system for molding/over molding a depression as part of a back side for a housing of the mobile computing unit, according to one aspect of the subject innovation. Initially, the injection unit 900 melts the polymer resin and injects the polymer melt into the molding space 902 that can house the back cover and housing components in preparation for molding. The employed resin can comprise various types of thermoset plastic or thermo plastic material such as polybutylene terephthalate, polyethylene terephthalate, polyphenylene sulfide, diallyl phthalate, phenolic resins, and the like. The resin material can be injected on to desired locations (e.g., to form the depression and/or groove of the grip security arrangement) via a rate sufficient to maintain an unbroken melt front, and to avoid any spraying or splashing of the plastic material within the mold cavity. In addition, the injection pressure and temperature can be regulated via a control unit 904, to moderate susceptibility of damage to the other molded/over molded components associated with the mobile computing unit.

The unit 900 may be ram fed or screw fed. The ram fed injection molding machine typically can employ a hydraulically operated plunger to push the plastic through a heated region. The high viscosity melt is then spread into a thin layer by a “torpedo” to allow for better contact with the heated surfaces. The melt converges at a nozzle 901 and is injected into the mold space 902, which can hold the back side in preparation for molding. The reciprocation screw injection molding machine employs a screw that rotates and axially reciprocates. Rotation is produced by a hydraulic motor and acts to melt, mix, and pump the polymer resin. A hydraulic system controls the axial reciprocation of the screw, allowing it to act like a plunger, moving the melt forward for injection. A valve prevents back flow of the melt from the mold cavity.

Next, the polymer flows from the nozzle 901 to the molding space 902, which can be coupled to the nozzle 901 by a sprue bushing (not shown). Typically, the injection mold 902 can include two mold halves that define a space for forming a housing including a back side and a front side associated with the mobile computing unit

Before injecting plastic material into the mold space 902, the mold space can be heated to a temperature above the melting point of the plastic material by circulating a heat carrier flowing through a heating device. During injection of plastic material, the flow of heat carrier can be stopped for maintaining the temperature of the mold. The injection process requirements can be regulated via a control unit 904 that includes a CPU. The control unit 904 can control and monitor, for example, the injection pressure until the molding of depression associated with a back side of the mobile computing unit, at which time the injection pressure is maintained until the plastic material has hardened around the common perimeter between the top and bottom portion of the housing.

After completely molding a depression and/or groove as part of the bottom cover, the mold 902 is cooled down. The molded back sided can be held in place via employment of a clamp assembly associated with the mold 902. The molding process can be controlled throughout, so that the molded depression as part of the bottom cover is not dislocated or damaged.

In a mold space 902 having multiple cavities, the melt flows to each cavity by runners and is fed to the cavity through a gate (not shown). The gate can simply act as a restriction in the flow path just ahead of the mold cavity, and serves to direct the flow of the melt into the cavity and to limit back flow. The gate can comprise a plurality of gate orifices located near the edges of the mold cavity. These orifices can be located as to allow forwarding resin material into the mold cavity in roughly equal volumes on all free sides of the back side with the depression.

In addition, resin injection can be performed via gas assisted injection and non-gas assisted injection. Gas assisted injected mold processing generally comprises two steps. First, viscous thermoplastic is injected through runner conduits and gate conduits into mold cavities. Shortly thereafter gas is injected through the runners and gates to force the thermoplastic against the walls of the mold cavities to form the desired articles. In the case of non gas-assisted injection molding, there is no gas injection step.

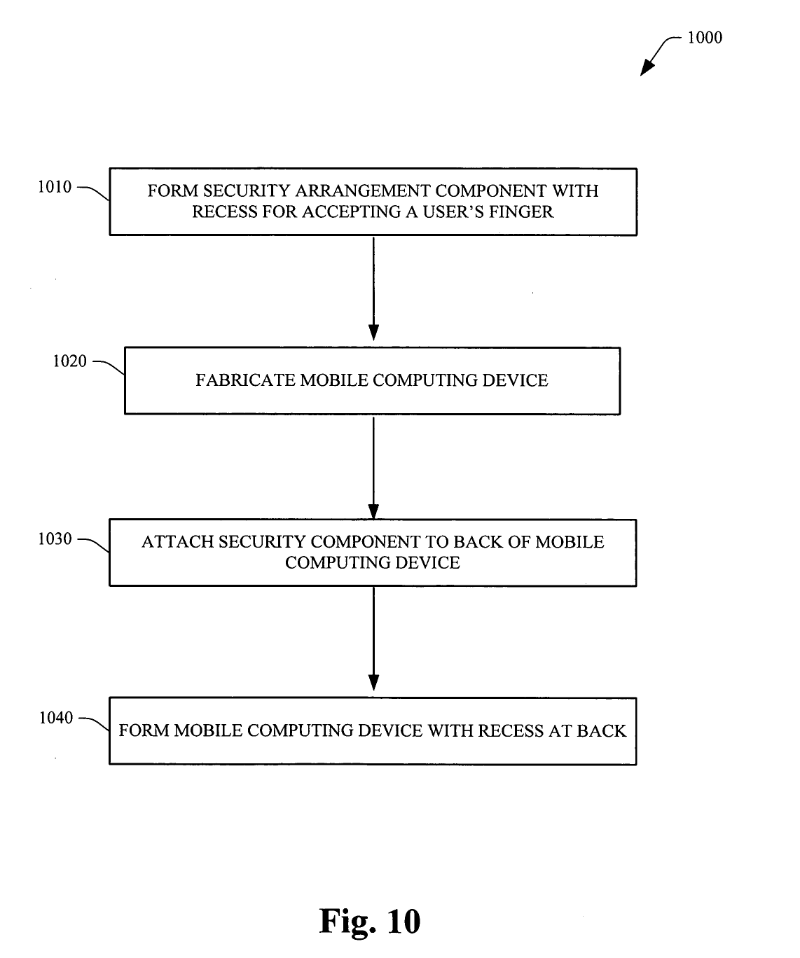

FIG. 10 illustrates a particular methodology 1000 in accordance with an aspect of the subject innovation, wherein the security arrangement can be a stand alone part that is connected to the mobile computing device, after a fabrication thereof. Initially, and at 1010 the security arrangement in form of a component with a recess for accepting a user's index finer is fabricated as a unit, which is separate from the mobile computing device. Next, and at 1020 the mobile computing device can be fabricated independent of the security arrangement component. At 1030, the security arrangement component can be attached to a back side of the mobile computing based on a user's preference for a location of the recess on the bask side. The mobile computing device can then be supplied to facilitate one handed operation by the user, at 1040. Accordingly, the depression associated with the security arrangement can receive a user's index finger and function as a pivot point to provide additional support for stability (e.g., moment and balance), for example. Thus, holding the device can be facilitated during one handed operation, wherein the user employs one hand for both grasping the device and operating therewith.

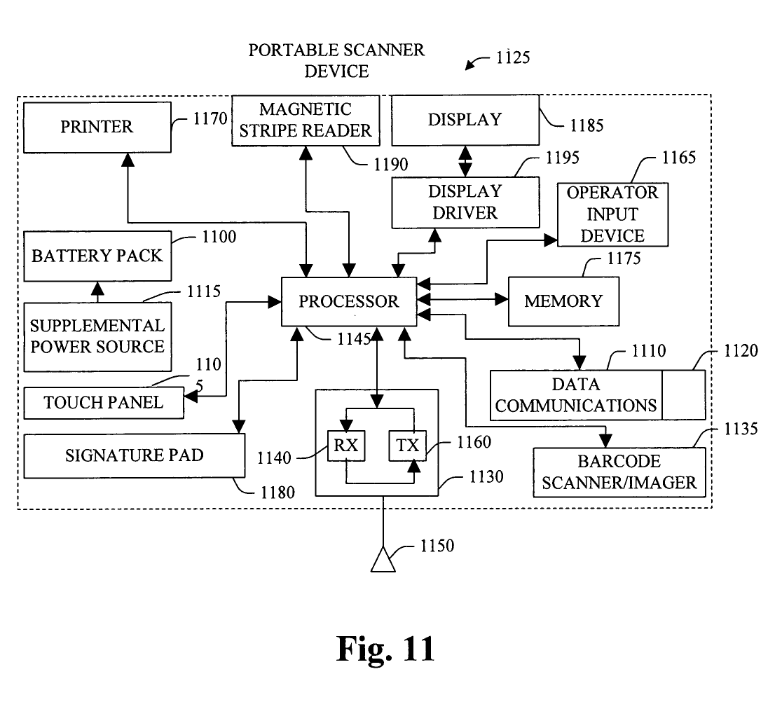

As explained earlier, the grip security arrangement of the subject innovation can be employed in a variety of electrical or electronic device that can require entry of a user's input via pressing alpha, alphanumerical designations or keys thereon. FIG. 11 illustrates a schematic block diagram for a host portable scanner unit 1125 that employs a grip security arrangement as described supra. As illustrated, a processor 1145 is responsible for controlling the general operation of a portable scanner device 1125 that employs a depression as discussed supra. The processor 1145 is programmed to control and operate the various components within the scanner device 1125 in order to carry out the various functions described herein. The processor or CPU 1145 can be any of a plurality of processors, such as the p24T, Pentium 50/75, Pentium 60/90, and Pentium 66/100, Pentium PRO and Pentium 2, and other similar and compatible processors or micro controllers. A processor such as Intel's 8 bit microcontrollers, the 8031, 8051 or 8052 can also be employed. The manner the processor 1145 can be programmed to carry out the functions relating to the operations of the scanner device will be readily apparent to those having ordinary skill in the art based on the description provided herein. A memory 1175 tied to the processor 1145 is also included in the portable scanner device 1125 and serves to store program code executed by the processor 1145 for carrying out operating functions of the scanner. The memory 1175 also serves as a storage medium for temporarily storing information such as receipt transaction information and the like. The memory 1175 is adapted to store a complete set of the information to be displayed. According to one particular aspect, the memory 1175 has sufficient capacity to store multiple sets of information, and the processor 1145 could include a program for alternating or cycling between various sets of display information.

Display(s) 1185 is coupled to the processor 1145 via a display driver system 1195. The display 1185 is operable to display data or other information relating to ordinary operation of the portable scanner 1125. For example, the display 1185 may display a set of customer information, which is displayed to the operator and may be transmitted over a system backbone (not shown). Additionally, the display 1185 may display a variety of functions that control the execution of the portable electronic device 1125. The display 1185 is capable of displaying both alphanumeric and graphical characters. Furthermore, as explained earlier the display 1185 may be a touch screen that is capable of receiving user information as well as displaying information.

Power is provided to the processor 1145 and other components forming the portable electronic device 1125 by a battery pack 1100, which is located in the top housing. In the event that the battery pack 1100 fails or becomes disconnected from the portable electronic device 1125, a supplemental power source 1115 provides power to the processor 1145, the supplemental power source 1115 being a super capacitor connected electrically in parallel with the battery 1100. The hand-held terminal 1125 may enter a minimum current draw of sleep mode upon detection of a battery failure.

The portable electronic device 1125 includes a communication subsystem 1130 that includes a data communication port employed to interface the processor 1145 with the main computer. The portable electronic device 1125 also optionally includes an RF section 1130 connected to the processor 1145. The RF section 1130 includes an RF receiver 1140, which receives RF transmissions from the main computer for example via an antenna 1150 and demodulates the signal to obtain digital information modulated therein. The RF section 1130 also includes an RF transmitter 1160 for transmitting information to the main computer, for example, in response to an operator input, or the completion of a transaction. Peripheral devices, such as a printer 1170, signature pad 1180, magnetic stripe reader 1190, touch panel 1105, can also be coupled to the portable scanner device 1125 through the processor 1145.

Although the innovation has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the innovation.

In addition, while a particular feature of the innovation may have been disclosed with respect to only one of several implementations, such feature may be combined with one or more other features of the other implementations as may be desired and advantageous for any given or particular application. Furthermore, to the extent that the terms “includes”, “including”, “has”, “having”, and variants thereof are used in either the detailed description or the claims, these terms are intended to be inclusive in a manner similar to the term “comprising”.

What is claimed is:

1. A grip security arrangement for a hand held computing unit comprising:
a depression as part of a back side of the hand held computing unit, the depression accepts a user's finger to facilitate one handed operation with the hand held computing unit; and
a surface(s) associated with the depression to contour the user's finger.

2. The grip security arrangement of claim 1, the depression is a groove formed on a back side of the hand held computing unit.

3. The grip security arrangement of claim 2, the groove having an inclined ledge.

4. The grip security arrangement of claim 2, the groove having a vertical ledge.

5. The grip security arrangement of claim 1 further comprising elastometric material.

6. A mobile computing unit comprising:
a housing with a grip security arrangement attached to a back part thereof, the grip security arrangement having a depression that accepts a user's finger; and
a central processing unit placed within the housing, to control operation of the mobile computing unit.

7. The mobile computing unit of claim 6 the grip security arrangement molded as part of the housing.

8. The mobile computing unit of claim 6 the grip security arrangement attached as a separate unit to the housing.

9. The mobile computing unit of claim 6, the grip security arrangement with slip resistant characteristics.

10. The mobile computing unit of claim 6, the grip security arrangement symmetrical with respect to a longitudinal axis of the mobile computing unit.

11. A method of enhancing a grip security for a mobile computing unit comprising;
forming a depression as part of a back side of the mobile computing unit; and
accepting a user's finger by the depression.

12. The method of claim 11 further comprising balancing a weight of the mobile computing unit via the user's finger.

13. The method of claim 11 further comprising enabling adjustment of the user's finger position by the depression.

14. The method of claim 11 further comprising operating a keypad of the mobile computing unit during one handed operation and with a thumb of a hand that includes the user's finger.

15. The method of claim 14 further comprising mitigating inertial effects associated with motion of the thumb when touching the key pad, via adjusting an orientation of the user's finger.

16. The method of claim 14, the act of forming a depression further comprises forming a groove.

17. The method of claim 14, the act of forming a depression further comprises attaching a grip security attachment to the back side of the mobile computing unit.

18. The method of claim 17, further comprising forming the grip security arrangement as a separate unit.

19. The method of claim 18 further comprising employing slip resistant texture as part of the depression.

20. A grip security arrangement for a hand held computing unit comprising:
means for enabling a balance for a weight of the hand held computing unit by a user's finger; and
means for contouring the user's finger to facilitate operating the hand held computing unit.
